(19) United States
(12) Patent Application Publication
(10) Pub. No.: US 2025/0121787 A1
(43) Pub. Date: Apr. 17, 2025

(54) DEFORMATION ARRANGEMENT FOR A VEHICLE

(71) Applicant: Benteler Automobiltechnik GmbH, Paderborn (DE)

(72) Inventors: Elmar MOLLEMEIER, Delbrueck (DE); Dariusz STRAZNIKIEWICZ, Paderborn (DE); Annika SCHULTZ, Paderborn (DE); Frank RABE, Hiddenhausen (DE); Havard SORLIE, Moelv (NO)

(21) Appl. No.: 18/908,439

(22) Filed: Oct. 7, 2024

(30) Foreign Application Priority Data
Oct. 11, 2023 (DE) 10 2023 127 766.9

(51) Int. Cl. B60R 19/34; B60R 19/03

(52) U.S. Cl. CPC B60R 19/34; B60R 19/03

(57) ABSTRACT

The disclosure relates to a deformation arrangement for a vehicle, including a bumper cross member and a deformation element connected to the bumper cross member, where the deformation element has a deformation element end at a side facing away from the bumper cross member and a contact element having a first contact element part and a second contact element part, where the contact element has at least one deformable hinge region, which connects the second contact element part to the first contact element part, and where the deformable hinge region is adapted to absorb, in the event of a crash, a force acting on the deformation element and displacing the deformation element at least partially by deforming the deformable hinge region, and thereby causing a displacement and a pivoting of the second contact element part relative to the first contact element part.

### CROSS-REFERENCE

The present application claims the benefit of German Patent Application No. 10 2023 127 766.9 by Mollemeier et al., entitled “DEFORMATIONSANORDNUNG FÜR EIN FAHRZEUG”, filed Oct. 11, 2023, which is assigned to the assignee hereof and is incorporated by reference in its entirety.

### TECHNICAL FIELD

The present disclosure relates to a deformation arrangement for a vehicle, in particular a deformation arrangement comprising a bumper cross member, a deformation element, and a contact element, which can be connected to a vehicle longitudinal member.

### BACKGROUND

Conventional deformation arrangements for vehicles comprise deformation elements, which are arranged between the bumper cross member and the vehicle longitudinal member. In the event of a crash, corresponding deformation elements can absorb a force acting on the bumper cross member by deforming, thereby preventing damage to other components of the vehicle body.

However, conventional deformation elements often have the disadvantage that they often cannot effectively limit the bending moments acting on the components of the deformation arrangement, are complex to manufacture, and are often formed from different materials and several components.

The publication DE 10 2021 115 455 A1 discloses a vehicle frame for an electrically powered vehicle.

The publication DE 10 2016 116 172 A1 discloses a load introduction system of a vehicle for introducing a load against the direction of travel of the vehicle.

### SUMMARY

It is the object of the present disclosure to provide an efficient deformation arrangement for a vehicle.

This object is achieved by the features of the independent claims. Advantageous examples are the subject of the dependent claims, the description, and the accompanying figures.

The present disclosure is based on the finding that the use of a one-piece and material-uniform contact element between the deformation element of the deformation arrangement and the vehicle longitudinal member enables an effective structural connection of the deformation element to the vehicle longitudinal member, wherein a deformable hinge region of the contact element causes a deformation of the contact element such, that an effective limitation of the bending moment is achieved.

According to a first aspect, the disclosure relates to a deformation arrangement for a vehicle, comprising: a bumper cross member, which extends along a vehicle transverse axis; and a deformation element, which extends along a vehicle longitudinal axis and which is connected to the bumper cross member in a materially bonded or force-fitting manner, in particular by screws, wherein the deformation element has a deformation element end at a side facing away from the bumper cross member and a contact element made of a steel or aluminum alloy arranged at the deformation element end, which is connectable to a vehicle longitudinal member extending along the vehicle longitudinal axis, wherein the contact element has a first contact element part and a second contact element part, which are formed in one piece in the contact element, wherein the first contact element part is connectable to the vehicle longitudinal member, and wherein the second contact element part is connected to the deformation element in a materially bonded manner, wherein the contact element has at least one deformable hinge region, which connects the second contact element part to the first contact element part, wherein the deformable hinge region is adapted to absorb, in the event of a crash, a force acting on the deformation element and displacing the deformation element at least partially by deforming the deformable hinge region, and thereby causing a displacement and a pivoting of the second contact element part relative to the first contact element part.

This achieves the technical advantage that within the deformation arrangement a connection between the deformation element and the vehicle longitudinal member is provided, which can advantageously be deformed in the event of a crash of the vehicle.

The contact element arranged at the end of the deformation element is made of a steel or aluminum alloy and is therefore a component that can be produced cost-effectively in series and has a one-piece and material-uniform design.

The forces that can be transmitted by the contact element can be advantageously adjusted by the size of the surface of the contact element and the hardness or tensile strength of the two contact element parts of the contact element. In addition, the bending moment is limited by means of the internal friction of the deformable hinge region.

The shape, size, and strength of the first and second contact element parts can be changed depending on the structural components to be fastened and the forces to be transmitted.

The shape, size, strength, position, and number of the deformable hinge regions and/or the size, position, and number of the joints can also be changed depending on the forces to be transmitted and the bending moment to be limited.

In particular, the deformable hinge region is adapted, in the event of a crash, to cause a force acting on the deformation element and displacing the deformation element at least partially by pivoting the second contact element part relative to the first contact element part about a vehicle vertical axis extending through the deformable hinge region, wherein the vehicle vertical axis extends transversely to the vehicle transverse axis and also transversely to the vehicle longitudinal axis.

In addition, in the event of a crash, a force acting on the deformation element along the vehicle longitudinal axis and displacing the deformation element can at least partially cause a displacement of the second contact element part relative to the first contact element part, in particular as part of a superposition of rotation and translation.

According to an example, the first contact element part and the second contact element part are formed of a uniform material and in one piece in the contact element.

This achieves the technical advantage that an advantageous production of the contact element can be achieved.

According to an example, the first contact element part is formed as a first contact element plate, and the second contact element part is formed as a second contact element plate, which is connected to the first contact element plate by the deformable hinge element, and wherein in particular the first contact element plate and the second contact element plate are aligned gap-free and/or substantially plane-parallel to one another in the normal state of the deformation arrangement.

Within the scope of the disclosure, the specification substantially plane-parallel also includes deviations from mathematical parallelism in a range of −5 to +5 degrees.

This achieves the technical advantage that by forming the two contact element parts as contact element plates, in particular a gap-free and/or plane-parallel alignment to one another, a particularly stable design of the contact element is achieved in the normal state, i.e. in the undeformed state of the contact element. In addition, both the vehicle longitudinal member and the deformation element, as well as their joint connection, can be adapted and implemented conventionally without special precautions.

According to an example, the deformable hinge region is formed by a reshaped edge and/or a circular arc section of the second contact element part, in particular of the second contact element plate, which is formed in one piece with an edge of the first contact element part, in particular of the first contact element plate.

This achieves the technical advantage that a correspondingly reshaped edge and/or a circular arc section of the second contact element part introduces a local structural weakening into the deformable hinge region, so that deformation and displacement are possible in the event of a crash.

According to an example, the deformable hinge region is arranged at an inner side of the contact element facing away from the vehicle outer side in an installed state in the vehicle.

This achieves the technical advantage that in the event of a crash during a central pile test, an advantageous inward deformation of the contact element is ensured.

According to an example, the second contact element part has a predetermined breaking point region, wherein the deformable hinge region is adapted to cause a defined break in the connection in the predetermined breaking point region in the event of a crash, in particular in a central pile test, by the deformation of the deformable hinge region, and thereby causing a displacement and a pivoting of the second contact element part relative to the first contact element part.

This achieves the technical advantage that a corresponding predetermined breaking point region of the second contact element part enables a locally limited break-up of the second contact element part, and thus enables the second contact element part to pivot relative to the first contact element part at a predefined force level. This relieves the load on the joints between the deformation element and the contact element, as well as between the contact element and the vehicle longitudinal member, and reliably prevents undefined deformation or tearing.

In particular, the predetermined breaking point region is arranged at an outer side of the contact element facing the vehicle outer side, wherein in particular the predetermined breaking point region and the deformable hinge region are arranged on opposite sides of the contact element.

In particular, the predetermined breaking point region comprises a region of the second contact element part, which has a lower hardness than a hardness of the remaining region of the second contact element part, and wherein the predetermined breaking point region is adapted in particular as a softened or incompletely hardened soft strip.

Alternatively, the predetermined breaking point region has a perforation or a lower wall thickness than the rest of the contact element.

According to an example, the second contact element part is connected to the first contact element part by a detachable connection, wherein the deformable hinge region is adapted to cause a detachment of the detachable connection in the event of a crash by the deformation of the deformable hinge region, and thereby causing a displacement and a pivoting of the second contact element part relative to the first contact element part.

This achieves the technical advantage that the detachable connection ensures that an effective displacement and an effective pivoting of the second contact element part relative to the first contact element part are possible.

According to an example, the detachable connection is arranged at an outer side of the contact element facing the vehicle outer side, and wherein the detachable connection and the deformable hinge region are arranged on opposite sides of the contact element.

This achieves the technical advantage that a predetermined and directed deformation of the contact element is ensured in the event of a crash.

According to an example, the detachable connection comprises a detachable form-fitting and/or force-fitting connection between the first and second contact element parts.

According to an example, the detachable form-fitting connection and/or the detachable force-fitting connection comprises a bending point arranged at the edge of the first and/or second contact element part, which is connected to the second or first contact element part, and/or the detachable form-fitting connection and/or detachable force-fitting connection comprises a projection of the first and/or second contact element part, which is received in a receptacle of the second and/or first contact element part.

This achieves the technical advantage that the mentioned designs of corresponding detachable connections enable an advantageous directed displacement and an advantageous directed pivoting of the second contact element part relative to the first contact element part. This in turn relieves the load on the joints between the deformation element and the contact element, as well as between the contact element and the vehicle longitudinal member, and reliably prevents undefined deformation or tearing.

According to an example, the detachable connection is adapted as a tab formed at an edge of the first contact element part and/or at an edge of the second contact element part, which tab engages over the edge region of the respective other contact element part in order to form a form-fitting or force-fitting connection between the first and second contact element parts.

This achieves the technical advantage that an advantageous detachable connection can be formed by the tab.

According to an example, the deformable hinge region is adapted such that in the event of a crash, in particular a center pole crash, an effective displacement and an effective pivoting of the second contact element part relative to the first contact element part are caused by the deformable hinge region when the force displacing the deformation element exceeds a predetermined force threshold value, wherein in particular the predetermined force threshold value is smaller than a maximum resistance force of a joint connection between the deformation element and the contact element.

This achieves the technical advantage that no unnecessary deformation of the contact element is triggered when very low forces act on the contact element or in other crash scenarios or other crash tests such as “RCAR Structure” or “RCAR Bumper”.

According to an example, the deformable hinge region is adapted, in the event of a crash, to cause a restoring bending moment that is opposite to the deformation of the deformable hinge region in order to limit the displacement of the second contact element part relative to the first contact element part and at the same time to dissipate crash energy.

This achieves the technical advantage that even if a large force acts in the event of a crash, the displacement of the second contact element part relative to the first contact element part cannot occur indefinitely, thereby increasing safety in the event of a crash.

According to an example, in the event of a crash, the deformable hinge region is adapted to cause a rotation of the second contact element part relative to the first contact element part around a vehicle vertical axis extending transversely to the vehicle longitudinal axis and transversely to the vehicle transverse axis when a force acts on the deformation element and displaces the deformation element, and/or the deformable hinge region is adapted to cause a translation of the second contact element part relative to the first contact element part along the vehicle longitudinal axis when a force acts on the deformation element and displaces the deformation element.

This achieves the technical advantage that a directed rotation of the second contact element part relative to the first contact element part enables an effective absorption of the acting forces.

According to an example, an opening is formed respectively in the first contact element part, in particular in the first contact element plate, and in the second contact element part, in particular in the second contact element plate, and wherein the openings are arranged in alignment with one another in the normal state of the deformation arrangement.

This achieves the technical advantage that the weight of the contact element can be reduced through the respective opening without negatively affecting the mechanical properties of the contact element.

According to an example, a plurality of elevations and/or depressions and/or a circumferential edge change are formed in the first contact element part, in particular in the first contact element plate, and/or in the second contact element part, in particular in the second contact element plate.

This achieves the technical advantage that by introducing elevations and/or depressions, the structural properties of the contact element can be locally optimized, and in particular the bending stiffness outside the hinge region and a possible existing detachable connection can be increased.

According to an example, the first contact element part has a plurality of openings, through each of which a fastening element, in particular a fastening screw, can be guided, and which is adapted to fasten the first contact element part to the vehicle longitudinal member, in particular to a further contact element, in particular to a further contact element plate, of the vehicle longitudinal member.

This achieves the technical advantage that an effective attachment to the vehicle longitudinal member is ensured.

According to an example, the contact element is formed as a sheet metal part, wherein the hinge region is formed by bending. Alternatively, the contact element is made by extrusion of an extruded profile, including the hinge region, and in particular from an aluminum alloy.

This achieves the technical advantage that an easy manufacturing is given.

According to an example, the deformable hinge region, and in particular also the predetermined breaking point region, is formed as a non-thermally hardened or as a thermally softened region of the contact element.

This achieves the technical advantage that a structural weakening can be advantageously introduced into the respective region.

According to an example, the first contact element part and the second contact element part, with the exception of the deformable hinge region, and in particular also with the exception of the predetermined breaking point region, are formed as a thermally hardened or thermally softened region of the contact element.

This achieves the technical advantage that a structural stability can be achieved in the further region of the contact element.

According to an example, the first contact element part, in particular the first contact element plate, and the second contact element part, in particular the second contact element plate, are joined to one another at least partially by at least one joint, in particular joined to one another in a frictionally engaged and/or materially engaged manner.

This achieves the technical advantage that a structurally stable connection between the first and second contact element parts can be achieved.

According to an example, the deformable hinge region is adapted to separate the joint between the first contact element part and the second contact element part by the resulting displacement of the second contact element part relative to the first contact element part, when the force displacing the deformation element is greater than a connecting force provided by the joint.

This achieves the technical advantage that an effective limitation is introduced.

According to an example, a plurality of elevations and/or depressions are formed in the deformable hinge region.

This achieves the technical advantage that thereby the deformability of the deformable hinge region can be advantageously adjusted.

According to a second aspect, the disclosure relates to a system comprising a deformation arrangement according to the first aspect and a vehicle longitudinal member extending along the vehicle longitudinal axis, which is connected to the first contact element part of the contact element.

This achieves the technical advantage that an effective device for absorbing forces in the event of a crash is provided.

The advantageous examples described for the deformation arrangement according to the first aspect are also advantageous examples for the system according to the second aspect.

### BRIEF DESCRIPTION OF THE DRAWINGS

Further examples are explained with reference to the accompanying figures. It is shown in:

FIG. 1 a schematic representation of a deformation arrangement for a vehicle according to an example;

FIGS. 2A and 2B schematic representations of contact elements of a deformation arrangement shown in FIG. 1 according to an example;

FIG. 3 a schematic representation of the contact element shown in FIG. 2B with a deformation element according to an example;

FIG. 4 a schematic representation of a deformation arrangement according to a further example;

FIGS. 5A and 5B schematic representations of contact elements of a deformation arrangement shown in FIG. 1 according to different examples; and

FIG. 6 a schematic representation of a contact element according to a further example.

### DETAILED DESCRIPTION

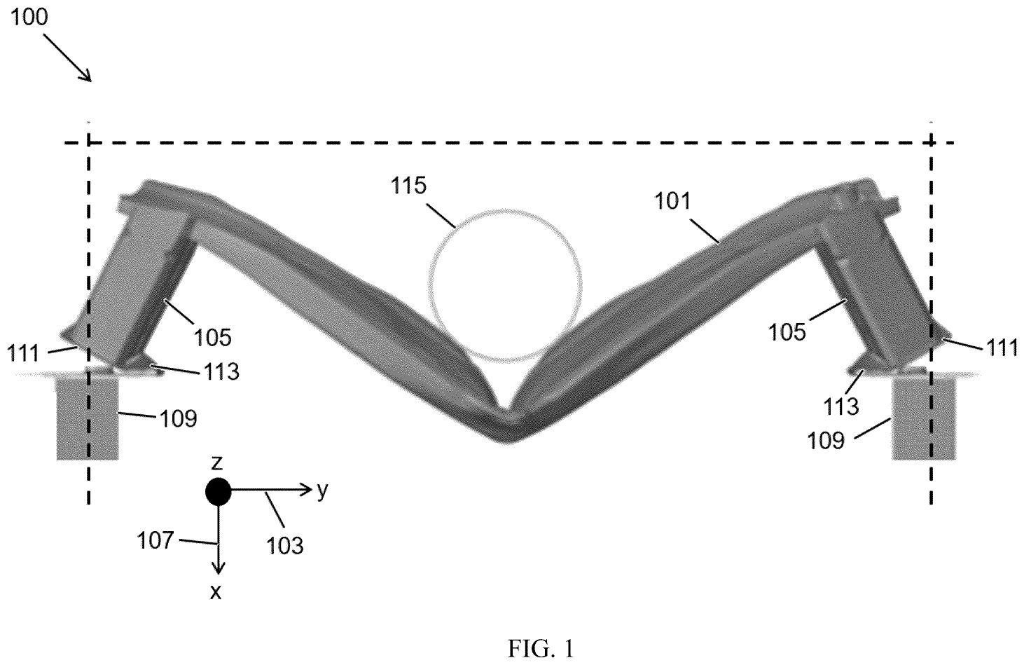

FIG. 1 shows a schematic representation of a deformation arrangement for a vehicle according to an example.

The deformation arrangement 100 shown in FIG. 1 is shown with correspondingly deformed components in the event of a crash. For the original state of the components of the deformation arrangement 100, it is referred to the dashed lines in FIG. 1.

The deformation arrangement 100 comprises a bumper cross member 101 which, in its original state, apart from a slight curvature pointing away from the vehicle, extends along a vehicle transverse axis 103 which corresponds to the y-direction in FIG. 1.

The deformation arrangement 100 further comprises a deformation element 105 which, in the original state, extends along a vehicle longitudinal axis 107 and which is connected to the bumper cross member 101 in a materially bonded or force-fitting manner, in particular by means of screws. The vehicle longitudinal axis 107 corresponds to the x-direction in FIG. 1.

The deformation element 105 can be connected to a vehicle longitudinal member 109 extending along the vehicle longitudinal axis 107.

It can be seen from FIG. 1 that the deformation arrangement 100 comprises two deformation elements 105, which are connected to opposite ends of the bumper cross member 101, wherein each of the two deformation elements 105 can be connected to a vehicle longitudinal member 109 in order to achieve a symmetrical stabilization.

It can also be seen from FIG. 1 that a deformation element end 111 is arranged on a side of the deformation element 105 facing away from the bumper cross member 101. Here, the deformation element 105 has a contact element 113 made of a steel or aluminum alloy arranged on the deformation element end 111, which contact element 113 can be connected to the vehicle longitudinal member 109.

It can be seen from FIG. 1 that the contact element 113 is deformable in the event of a crash, in particular deformable like a hinge, and thus enables a displacement and pivoting of the respective deformation element 105 relative to the vehicle longitudinal member 109.

As shown by the obstacle 115 shown schematically in FIG. 1, the impact of the vehicle on the obstacle 115, or the contact of the obstacle 115 with the bumper cross member 101, leads to a buckling of the bumper cross member 101 in the vehicle longitudinal direction 107 and thus to an end-side displacement of the deformation elements 105 along the vehicle transverse direction 103.

This generates a bending moment, which, however, does not lead to a deformation of the respective vehicle longitudinal members 109 but rather of the contact elements 113, as shown in FIG. 1, so that an effective limitation of the bending moment acting on the respective vehicle longitudinal members 109 is achieved.

For a further detailed description of the deformable contact element 113, reference is made to the following explanations.

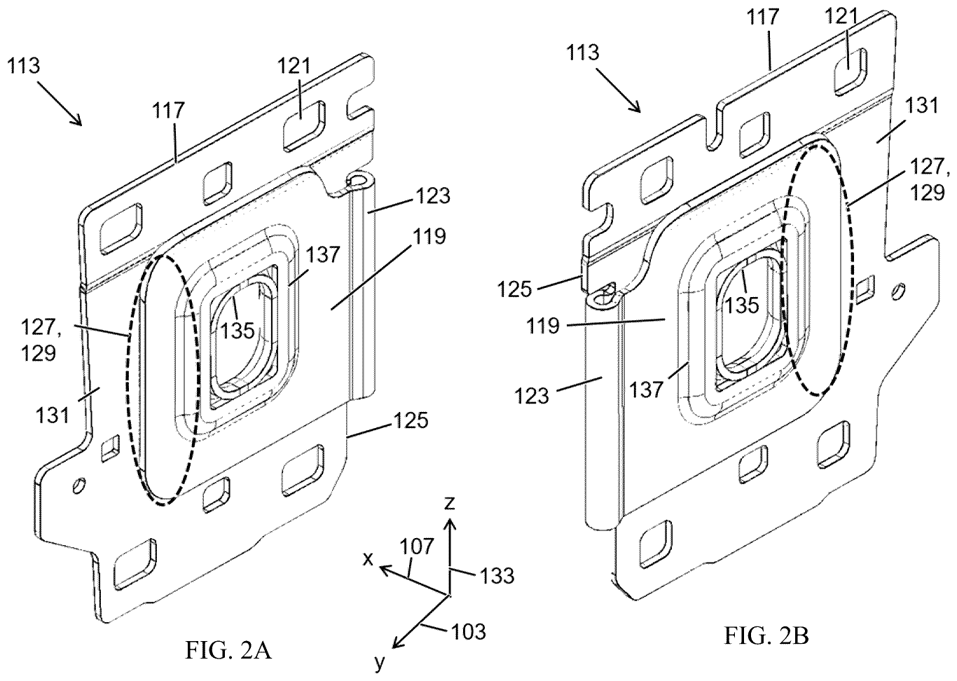

FIGS. 2A and 2B show schematic representations of contact elements of a deformation arrangement shown in FIG. 1 according to an example.

For a better assignment of the orientation of the contact elements 113 of FIGS. 2A and 2B with respect to the deformation arrangement 100 shown in FIG. 1, reference is made to the x-, y-, and z-directions shown in both FIG. 1 and FIGS. 2A and 2B.

What is crucial is that in FIGS. 2A and 2B, in contrast to FIG. 1, the non-deformed state of the contact elements 113 is shown, i.e. the original state before the crash.

As can be seen from FIGS. 2A and 2B, the contact element 113 has a first contact element part 117, or a first contact element plate, and a second contact element part 119, or a second contact element plate, which are formed in one piece in the contact element 113.

In the example according to FIGS. 2A and 2B, the first and second contact element plates are aligned plane-parallel to each other.

Here, the first contact element part 117 can be connected to the vehicle longitudinal member 109 not shown in FIGS. 2A and 2B. The second contact element part 119 is materially connected, in particular welded, to the deformation element 105 not shown in FIGS. 2A and 2B.

In FIGS. 2A and 2B, a plurality of openings 121 of the first contact element part 117 are shown, through each of which a fastening element, in particular a fastening screw, can be guided and is adapted to fasten the first contact element part 117 to the vehicle longitudinal member 109, in particular to a further contact element not shown in FIGS. 2A and 2B, in particular to a further contact element plate, of the vehicle longitudinal member 109.

The connection between the second contact element part 119 and the deformation element 105 is materially bonded or is made by welding.

It can be seen from both FIGS. 2A and 2B that the respective contact element 113 has a deformable hinge region 123, which connects the second contact element part 119 to the first contact element part 117.

The deformable hinge region 123 is adapted to absorb, in the event of a crash, a force acting on the deformation element 105 and displacing the deformation element 105 at least partially by deforming the deformable hinge region 123 (analogous to the illustration in FIG. 1), and thereby causing a displacement and pivoting of the second contact element part 119 relative to the first contact element part 117 (as is not shown in FIGS. 2A and 2B).

It can be seen from FIGS. 2A and 2B that the deformable hinge region 123 is formed in particular by a reshaped edge of the second contact element part 119, which is formed in one piece with an edge of the first contact element part 117.

Alternatively, the deformable hinge region 123 can also be formed by a circular arc section of the second contact element part 119.

Here, the deformable hinge region 123 is arranged at an inner side 125 of the contact element 113 facing away from the vehicle outer side, which ensures that the deformable hinge region 123 can be pivoted open on the inside as shown in FIG. 1.

Here, the second contact element part 119 is connected to the first contact element part 117 in particular by a detachable connection 127, which is shown schematically in FIGS. 2A and 2B, wherein the deformable hinge region 123 is adapted to cause a detachment of the detachable connection in the event of a crash upon reaching a defined force level by the deformation of the deformable hinge region 123 and thereby cause a displacement of the second contact element part 119 relative to the first contact element part 117.

The corresponding detachable connection 127 can in particular additionally comprise a predetermined breaking point region 129 of the second contact element part 119, wherein the deformable hinge region 123 is adapted to cause a break in the connection in the predetermined breaking point region 129 in the event of a crash when a defined force level is exceeded by the deformation of the deformable hinge region 123 and thereby cause a displacement and pivoting of the second contact element part 119 relative to the first contact element part 117.

The detachable connection 127 or the predetermined breaking point region 129 is arranged at an outer side 131 of the contact element 113 facing the vehicle outer side, and wherein the detachable connection 127 or the predetermined breaking point region 129 and the deformable hinge region 123 are arranged on opposite sides of the contact element 113. This allows the contact element 113 to be pivoted open as shown in FIG. 1.

The detachable connection 127 comprises in particular a detachable form-fitting and/or force-fitting connection between the first and second contact element parts 117, 119, wherein the detachable material-fitting connection comprises in particular a spot welding of the first to the second contact element part 117, 119.

In particular, the deformable hinge region 123 is adapted such that in the event of a crash, in particular a center pole crash, the deformable hinge region 123 causes an effective displacement of the second contact element part 119 relative to the first contact element part 117 when the force displacing the deformation element 105 exceeds a predetermined force threshold value, wherein in particular the predetermined force threshold value is smaller than a maximum resistance force of a joint connection between the deformation element 105 and the contact element 113. The displacement greatly relieves the load on this joint connection and prevents tearing or undefined deformation of the contact element.

In particular, the deformable hinge region 123 is adapted, in the event of a crash, to cause a rotation of the second contact element part 119 relative to the first contact element part 117 about a vehicle vertical axis 133 (corresponds to the z-axis in FIG. 1) extending transversely to the vehicle longitudinal axis 107 and transversely to the vehicle transverse axis 103 when a force acts on the deformation element 105 and displaces the deformation element 105, and/or the deformable hinge region 123 is adapted to cause a translation of the second contact element part 119 relative to the first contact element part 117 along the vehicle longitudinal axis 107 in the event of a force acting on the deformation element 105 and displacing the deformation element 105.

It can also be seen from FIGS. 2A and 2B that an opening 135 is formed in each of the first contact element part 117 and in the second contact element part 119, and wherein the openings 135 are arranged in alignment with one another in the normal state of the deformation arrangement 100.

Here, a plurality of elevations 137 and/or depressions can be formed in the first and/or second contact element part 117, 119.

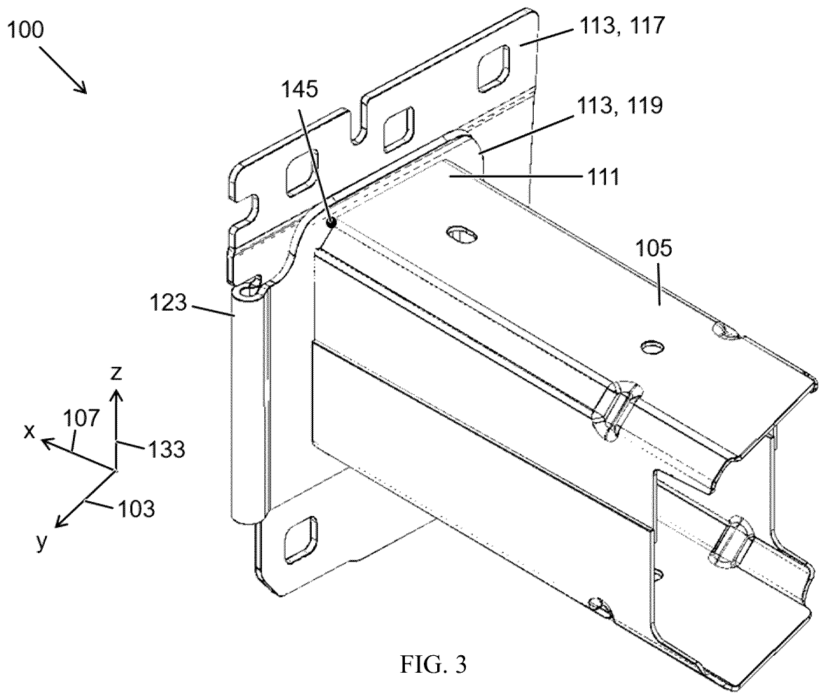

FIG. 3 shows a schematic representation of the contact element shown in FIG. 2B with a deformation element according to an example.

It can be seen from FIG. 3 that the deformation element 105 is firmly attached to the second contact element part 119 of the contact element 113 by the deformation element end 111 (wherein a corresponding welded connection 145 is shown schematically here), so that an effective crash-resistant connection between the contact element 113 and the deformation element 105 is achieved at a low force level. In addition, it can be seen in FIG. 3 that the edges of the opening 135 are shaped in such a way that they support each other in the Y and Z directions, and thus the first contact element plate and the second contact element plate hook onto the deformation element in the event of oblique loading, in particular in an “RCAR structure” or “RCAR bumper” test.

For the function of the deformable hinge region 123, reference is made to the previous explanations.

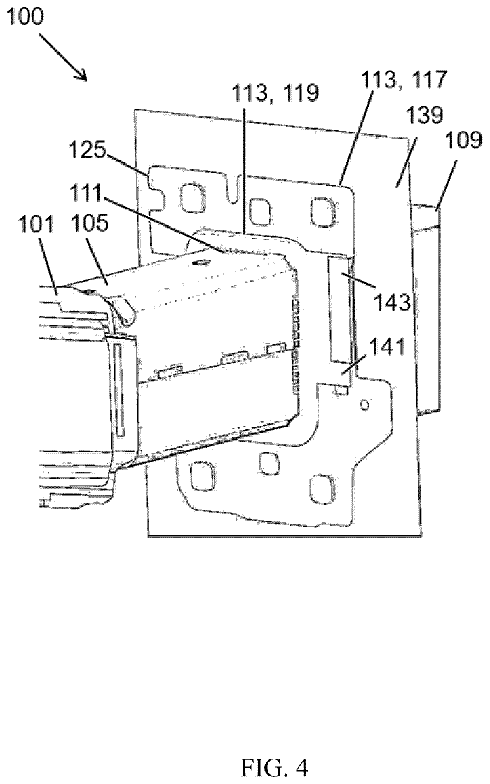

FIG. 4 shows a schematic representation of a deformation arrangement according to a further example.

The normal state is shown in FIG. 4.

FIG. 4 shows the bumper cross member 101 connected to the deformation element 105 of the deformation arrangement 100, wherein a deformation element end 111 of the deformation element 105 is connected to the second contact element part 119 of the contact element 113. A first contact element part 117 of the contact element 113, which is formed in one piece with the second contact element part 119, is also shown in FIG. 4, wherein the first contact element part 117 is connected to the corresponding vehicle longitudinal member 109, in particular to a further contact element 139, in particular to a further contact element plate, of the vehicle longitudinal member 109.

In FIG. 4, the deformable hinge region 123 arranged on the inner side 125 is not visible. However, the detachable connection 127 on the outer side 131 of the contact element 113 is shown, which in the example shown in FIG. 4 comprises a projection 141 of the second contact element part 119, which is received in a receptacle 143 of the first contact element part 117.

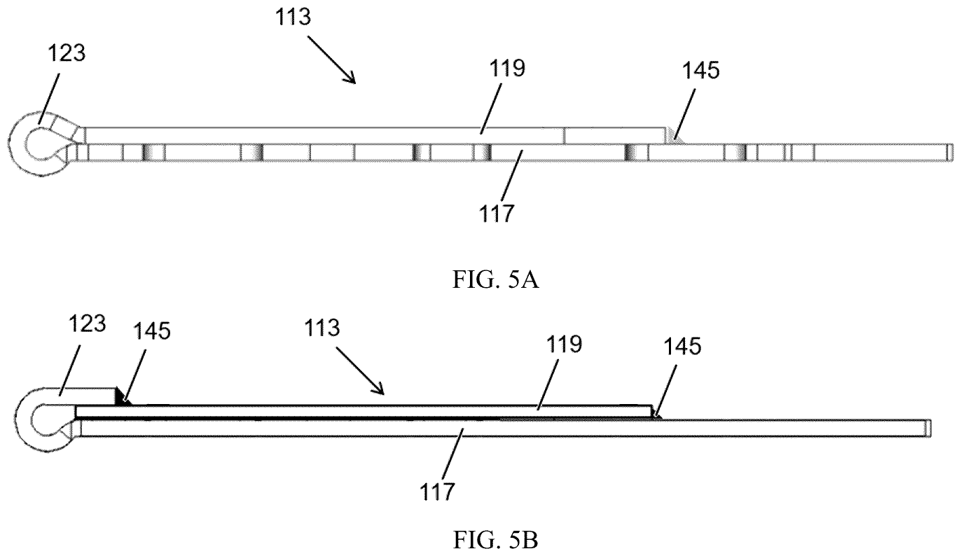

FIGS. 5A and 5B show schematic representations of contact elements of a deformation arrangement shown in FIG. 1 according to different examples.

FIGS. 5A and 5B show the respective contact element 113 in a cross-sectional view comprising the first contact element part 117 and the second contact element part 119 connected to the first contact element part 117 by the deformable hinge region 123.

FIG. 5A shows the variant in which the first contact element part 117, the second contact element part 119 and the deformable hinge region 123 are made in one piece, in particular as an extrusion molded part. A predetermined breaking point is formed on the side of the first contact element part 117 facing the hinge region in the form of a weld 145. This serves to maintain the gap-free and/or plane-parallel state of the contact element parts 117, 119 to one another up to a defined force level threshold, in particular during a tow hook pull-out test. After the extrusion of the contact element 113, the final shape is created by slight bending and/or press molding to ensure plane parallelism and/or gap-freeness and is ensured by the weld 145.

FIG. 5B shows the variant in which the first contact element part 117 and the deformable hinge region 123 are formed in one piece, in particular as a first extrusion component, and in which the second contact element part 119 is formed as a separate one-piece part, in particular as a second extrusion component. The second contact element part 119 is then welded at one end to the first contact element part 117 and at the other end to the deformable hinge region 123 in order to obtain the contact element 113. The contact element 113 shown in FIG. 5B is thus formed in two pieces, whereby the advantage is achieved, in particular compared to production from a semi-finished sheet metal product, that a reshaping of the deformable hinge region 123 is unnecessary when making the contact element 113.

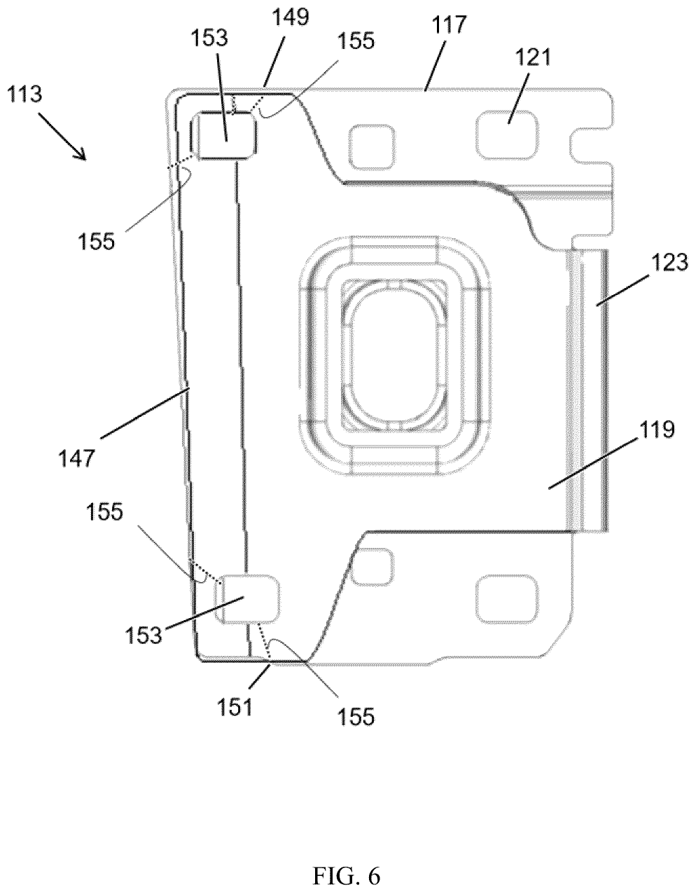

FIG. 6 shows a schematic representation of a contact element according to another example.

For the detailed description of the contact element 113, reference is made to the extensive explanations for FIG. 2. The contact element 113 shown in FIG. 6 has a first contact element part 117, a second contact element part 119, and a deformable hinge region 123 connecting these parts 117, 119.

The contact element 113 shown in FIG. 6 differs from the contact element 113 shown in FIG. 2 in that the second contact element part 119 is not limited to the middle, but rather the second contact element part 119 extends to the edge 147 of the first contact element part 117, which faces away from the deformable hinge region 123. In addition, the end of the second contact element part 119 extends to the upper edge 149 and to the lower edge 151 of the first contact element part 117.

Furthermore, it can be seen from FIG. 6 that the second contact element part 119 has two further openings 153 at the end of the second contact element part 119, which are each arranged in alignment with the openings 121 of the first contact element part 117, so that corresponding fastening screws for fastening to the vehicle body are guided both through the two corresponding openings 121 of the first contact element part 117 and through the two aligned further openings 153 of the second contact element part 119.

In the event of a crash, when the deformable hinge region 123 is bent, the connection between the end of the second contact element part 119 and the first contact element part 117 breaks close to the fastening screws (not shown in FIG. 6). Here in FIG. 6, corresponding predetermined breaking points 155 are marked schematically.

### REFERENCE NUMERALS

100 Deformation arrangement
101 Bumper cross member
103 Vehicle transverse axis
105 Deformation element
107 Vehicle longitudinal axis
109 Vehicle longitudinal member
111 Deformation element end
113 Contact element
115 Obstacle
117 First contact element part
119 Second contact element part
121 Opening
123 Deformable hinge region
125 Inner side of the contact element
127 Detachable connection
129 Predetermined breaking point region
131 Outer side of the contact element
133 Vehicle vertical axis
135 Opening
137 Elevation
139 Further contact element
141 Projection
143 Receptable
145 Weld
147 Edge of the first contact element part
149 Upper edge of the first contact element part
151 Lower edge of the first contact element part
153 Further openings of the second contact element part
155 Breaking point

What is claimed is:

1. A deformation arrangement for a vehicle, comprising:
a bumper cross member, which extends along a vehicle transverse axis; and
a deformation element, which extends along a vehicle longitudinal axis and which is connected to the bumper cross member in a materially bonded or force-fitting manner, wherein:
the deformation element has a deformation element end at a side facing away from the bumper cross member and a contact element made of a steel or aluminum alloy arranged at the deformation element end, which is connectable to a vehicle longitudinal member extending along the vehicle longitudinal axis,
the contact element has a first contact element part and a second contact element part, wherein the first contact element part is connectable to the vehicle longitudinal member, and wherein the second contact element part is connected to the deformation element in a materially bonded manner,
the contact element has at least one deformable hinge region, which connects the second contact element part to the first contact element part, and
the deformable hinge region is adapted to absorb, in the event of a crash, a force acting on the deformation element and displacing the deformation element at least partially by deforming the deformable hinge region, and thereby causing a displacement and a pivoting of the second contact element part relative to the first contact element part.

2. The deformation arrangement of claim 1, wherein the first contact element part and the second contact element part are formed of a uniform material and in one piece in the contact element.

3. The deformation arrangement of claim 1, wherein the first contact element part is formed as a first contact element plate, and wherein the second contact element part is formed as a second contact element plate, which is connected to the first contact element plate by the deformable hinge element, and wherein the first contact element plate and the second contact element plate are aligned gap-free and/or substantially plane-parallel to one another in a normal state of the deformation arrangement.

4. The deformation arrangement of claim 3, wherein the deformable hinge region is formed by a reshaped edge and/or a circular arc section of the second contact element plate, which is formed in one piece with an edge of the first contact element plate.

5. The deformation arrangement of claim 1, wherein the deformable hinge region is arranged at an inner side of the contact element facing away from a vehicle outer side in an installed state in the vehicle.

6. The deformation arrangement of claim 1, wherein the second contact element part has a predetermined breaking point region, and wherein the deformable hinge region is adapted to cause a defined break in the connection in the predetermined breaking point region in the event of a central pole crash, by the deformation of the deformable hinge region, thereby causing a displacement and a pivoting of the second contact element part relative to the first contact element part.

7. The deformation arrangement of claim 1, wherein the second contact element part is connected to the first contact element part by a detachable connection, and wherein the deformable hinge region is adapted to cause a detachment of the detachable connection in the event of a crash by the deformation of the deformable hinge region, thereby causing a displacement and a pivoting of the second contact element part relative to the first contact element part.

8. The deformation arrangement of claim 7, wherein the detachable connection is arranged at an outer side of the contact element facing a vehicle outer side, and wherein the detachable connection and the deformable hinge region are arranged on opposite sides of the contact element.

9. The deformation arrangement of claim 7, wherein the detachable connection comprises a detachable form-fitting and/or force-fitting connection between the first and second contact element parts.

10. The deformation arrangement of claim 9, wherein the detachable form-fitting and/or force-fitting connection comprises a bending point arranged at an edge of the first and/or second contact element part, which is connected to the second or the first contact element part, and/or wherein the detachable form-fitting and/or detachable force-fitting connection comprises a projection of the first and/or second contact element part, which is received in a receptacle of the second and/or first contact element part.

11. The deformation arrangement of claim 7, wherein the detachable connection is formed as a tab formed at an edge of the first contact element part and/or at an edge of the second contact element part, which tab engages over an edge region of the respective other contact element part in order to form a form-fitting or force-fitting connection between the first and second contact element part.

12. The deformation arrangement of claim 1, wherein the deformable hinge region is adapted such that in the event of a center pole crash, an effective displacement and an effective pivoting of the second contact element part relative to the first contact element part is caused by the deformable hinge region when the force displacing the deformation element exceeds a predetermined force threshold value, wherein the predetermined force threshold value is smaller than a maximum resistance force of a joint connection between the deformation element and the contact element.

13. The deformation arrangement of claim 1, wherein the deformable hinge region is adapted to cause a rotation of the second contact element part relative to the first contact element part about a vehicle vertical axis extending transversely to the vehicle longitudinal axis and transversely to the vehicle transverse axis in the event of a crash when a force acts on the deformation element and displaces the deformation element.

14. The deformation arrangement of claim 1, wherein an opening is respectively formed in the first contact element part (117) and in the second contact element part (119), and wherein the openings are arranged in alignment with one another in the normal state of the deformation arrangement.

15. The deformation arrangement of claim 1, wherein the first contact element part has a plurality of openings, through each of which a fastening element, in particular a fastening screw, can be guided, and which is adapted to fasten the first contact element part to a further contact element plate of the vehicle longitudinal member.

16. The deformation arrangement of claim 1, wherein the contact element is formed as a sheet metal part, wherein the hinge region is formed by bending, or wherein the contact element is made by extrusion of an extruded profile including the hinge region from an aluminum alloy.

17. A system, comprising:
a deformation arrangement for a vehicle, comprising:
a bumper cross member, which extends along a vehicle transverse axis; and
a deformation element, which extends along a vehicle longitudinal axis and which is connected to the bumper cross member in a materially bonded or force-fitting manner, wherein:
the deformation element has a deformation element end at a side facing away from the bumper cross member and a contact element made of a steel or aluminum alloy arranged at the deformation element end,
the contact element has a first contact element part and a second contact element part, wherein the second contact element part is connected to the deformation element in a materially bonded manner,
the contact element has at least one deformable hinge region, which connects the second contact element part to the first contact element part, and
the deformable hinge region is adapted to absorb, in the event of a crash, a force acting on the deformation element and displacing the deformation element at least partially by deforming the deformable hinge region, and thereby causing a displacement and a pivoting of the second contact element part relative to the first contact element part; and
a vehicle longitudinal member extending along the vehicle longitudinal axis, which is connected to the first contact element part of the contact element.

18. The system of claim 17, wherein the first contact element part and the second contact element part are formed of a uniform material and in one piece in the contact element.

19. The system of claim 17, wherein the first contact element part is formed as a first contact element plate, and wherein the second contact element part is formed as a second contact element plate, which is connected to the first contact element plate by the deformable hinge element, and wherein the first contact element plate and the second contact element plate are aligned gap-free and/or substantially plane-parallel to one another in a normal state of the deformation arrangement.

20. The system of claim 19, wherein the deformable hinge region is formed by a reshaped edge and/or a circular arc section of the second contact element plate, which is formed in one piece with an edge of the first contact element plate.
